(19) United States
(12) Patent Application Publication
(10) Pub. No.: US 2014/0102113 A1
(43) Pub. Date: Apr. 17, 2014

(54) EXHAUST HEAT RECOVERY FOR A GAS TURBINE SYSTEM

(71) Applicants: Jose Antonio Cuevas, Queretaro (MX); James Knox Prochaska, Spring, TX (US)

(72) Inventors: Jose Antonio Cuevas, Queretaro (MX); James Knox Prochaska, Spring, TX (US)

(73) Assignee: GENERAL ELECTRIC COMPANY, Schenectady, NY (US)

(21) Appl. No.: 13/525,243

(22) Filed: Jun. 15, 2012

(51) Int. Cl. F02C 7/047; F02C 7/224

(52) U.S. Cl. CPC F02C 7/047; F02C 7/224
USPC 60/779; 60/39.093; 60/736

(57) ABSTRACT

A system includes a gas turbine and an anti-icing system coupled to the gas turbine. The gas turbine is configured to receive air and fuel and to combust a mixture of the air and the fuel into exhaust gases. The anti-icing system is configured to use heat from the exhaust gases to heat a heat transfer fluid (HTF) and to selectively heat the fuel and the air via the HTF.

### BACKGROUND OF THE INVENTION

The subject matter disclosed herein relates to gas turbine systems, and more specifically, to heat recovery for the gas turbine systems.

A gas turbine engine combusts a mixture of fuel and air to generate hot exhaust gases. The exhaust gases may be used to rotate a load, such as an electrical generator. Unfortunately, in certain conditions, the moisture within the air supplied to the gas turbine engine may condense or even freeze, thereby reducing the operability and efficiency of the gas turbine engine. In addition, low fuel temperatures for certain fuels may result in sulfur deposition or condensation of the fuel into a liquid phase, which may reduce the operability of the gas turbine engine.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, system includes a gas turbine and an anti-icing system coupled to the gas turbine. The gas turbine is configured to receive air and fuel and to combust a mixture of the air and the fuel into exhaust gases. The anti-icing system is configured to use heat from the exhaust gases to heat a heat transfer fluid (HTF) and to selectively heat the fuel and the air via the HTF.

In a second embodiment, a system includes a turbine heat recovery controller. The turbine heat recovery controller includes reheating logic, anti-icing logic, and fuel heating logic. The reheating logic is configured to control the heating of a heat transfer fluid (HTF) using exhaust gases of a turbine system. The anti-icing logic is configured to control the heating of air of the gas turbine system using the HTF. The fuel heating logic is configured to control the heating of a fuel of the gas turbine system using the HTF.

In a third embodiment, a method includes detecting an air temperature of air using a first temperature sensor, and determining if an icing condition exists based on at least in part on the air temperature and a first temperature range. The method also includes heating the air within an air heat exchanger using a heat transfer fluid (HTF) when the icing condition exists. Further, the method includes reheating the HTF within an exhaust heat exchanger using an exhaust gas of a gas turbine when the icing condition does not exist. In addition, the method includes heating a fuel within a fuel heat exchanger using the HTF when the icing condition does not exist.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a gas turbine system having a gas turbine and an anti-icing system to increase the efficiency and operability of the gas turbine;

FIG. 2 is a schematic diagram of an embodiment of the gas turbine and the anti-icing system of FIG. 1, having a controller to implement various controller logic to increase the efficiency of the gas turbine; and

FIG. 3 is a flowchart illustrating an embodiment of a method for heating a fuel of a gas turbine using a heat transfer fluid to increase the efficiency of the gas turbine, in accordance with aspects of the present techniques.

### DETAILED DESCRIPTION OF THE INVENTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed towards systems and methods to recover heat from a gas turbine, thereby increasing the efficiency of a gas turbine system. In particular, an anti-icing system may use a heat transfer fluid (HTF) to extract waste heat from the gas turbine and to redistribute the waste heat among various components of the gas turbine system. For example, the HTF may extract heat from exhaust gases of the gas turbine and redistribute the heat to a fuel inlet and/or an air inlet to the gas turbine. Heating the air using the heat from the exhaust gases reduces the possibility of icing within the gas turbine system, thereby increasing the operability of the gas turbine system. In addition, heating the fuel using the heat from the exhaust gases improves the overall efficiency of the gas turbine system and reduces the possibility of sulfur deposition. In certain embodiments, a controller may be employed to selectively heat the air, the fuel, the HTF, or any combination thereof, based at least in part on operating conditions of the gas turbine system.

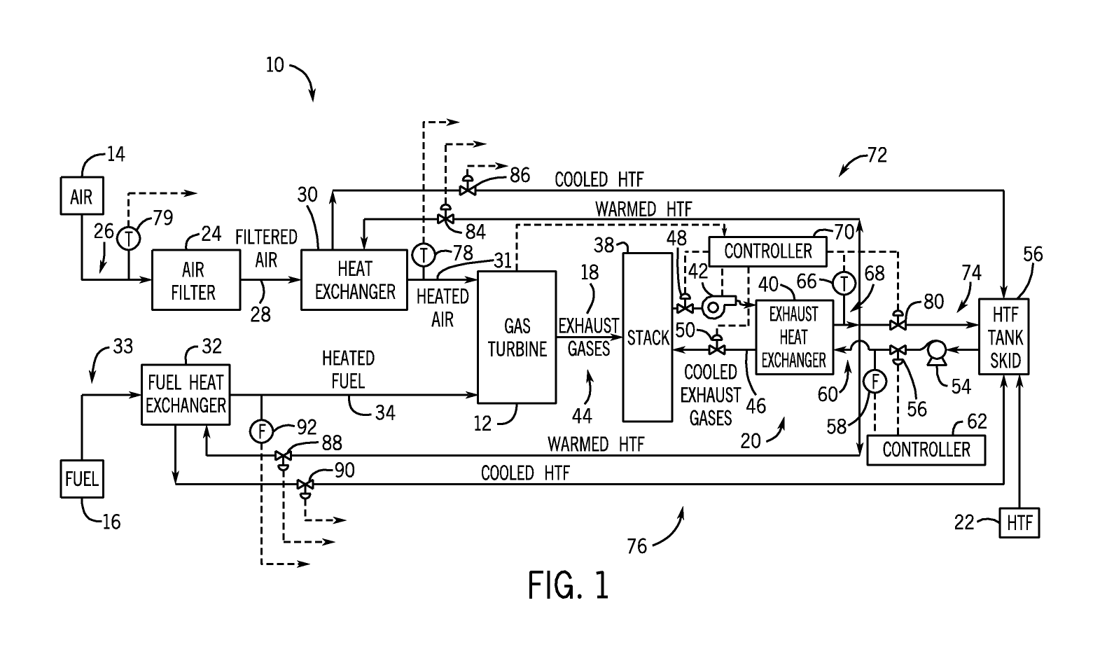

Turning now to the figures, FIG. 1 illustrates a gas turbine system 10 having a gas turbine 12. The gas turbine system 10 may be used within a variety of applications, industrial plants and the like. As shown, the gas turbine 12 receives a mixture of air 14 and fuel 16 and combusts the mixture of air 14 and fuel 16 into combustion products (e.g., exhaust gases 18). An anti-icing system 20 uses a heat transfer fluid (HTF) 22 to extract waste heat from the exhaust gases 18 and to redistribute the waste heat to the air 14 and the fuel 16, thereby increasing a temperature of the air and the fuel. As noted above, heating the air 14 using the HTF 22 reduces the possibility of icing within the gas turbine system 10, thereby improving the operability of the gas turbine system 10. In addition, heating the fuel 16 using the HTF 22 improves the overall efficiency of the gas turbine system 10. In certain embodiments, the HTF 22 may include water, glycol, hydrocarbons, other suitable heat transfer fluids, or any combination thereof. The HTF 22 may be designed based on a minimum ambient temperature, a freezing point of the HTF 22, a heat capacity of the HTF 22, or any combination thereof.

As illustrated, the gas turbine system 10 includes an air filter 24 disposed along a flow path 26 of the air 14. The air filter 24 reduces impurities or particulates from the air 14, and filtered air 28 exits the air filter 24. The filtered air 28 is directed to an air heat exchanger 30 of the anti-icing system 20. Although the air filter 24 is illustrated as upstream of the air heat exchanger 30, the number and placement of the air filter 24 may be implementation-specific. For example, the gas turbine system 10 may include 1, 2, 3, 4, or more air filters 24. In addition, the air filters 24 may be disposed upstream, downstream, or both, relative to the air heat exchanger 30. The air heat exchanger 30 is disposed along the air flow path 26 and upstream of the gas turbine 12. Within the air heat exchanger 30, the filtered air is heated by the HTF 22. In certain embodiments, the air heat exchanger 30 may be a coil type heat exchanger, a shell and tube heat exchanger, or another suitable type of heat exchanger. As shown, heated air 31 exits the air heat exchanger 30 and enters the gas turbine 12.

Similarly, a fuel heat exchanger 32 is disposed along a flow path 33 of the fuel 16 upstream of the gas turbine 12. Within the fuel heat exchanger 32, the fuel 16 is heated by the HTF 22. For example, the fuel heat exchanger 32 may be a shell and tube heat exchanger, and the fuel 16 and the HTF 22 may flow counter-currently relative to each other to exchange heat. However, other types of heat exchangers and/or flow arrangements may be envisioned, such as plate and frame heat exchangers with co-current flows, and the like. As shown, heated fuel 34 exits the fuel heat exchanger 32 and enters the gas turbine 12. The heated air 31 and heated fuel 34 are fed to the gas turbine 12 in a specified ratio suitable for emissions, combustion fuel consumption, and power output. The heated air 31 and heated fuel 34 combust within the gas turbine 12 and exit the gas turbine 12 as the exhaust gases 18. The exhaust gases 18 are directed to a stack 38, where the exhaust gases 18 may be vented to atmosphere. Additionally or alternatively, the exhaust gases 18 may be directed to an exhaust heat exchanger 40 of the anti-icing system 20, where waste heat from the exhaust gases 18 may be recovered to improve the efficiency of the gas turbine system 10.

As illustrated, a blower 42 is disposed along a flow path 44 of the exhaust gas 18. The blower 42 directs a portion of the exhaust gases 18 from the stack 38 to the exhaust heat exchanger 40. The exhaust heat exchanger 40 is disposed along the exhaust gas flow path 44 and downstream of the gas turbine 12. Within the exhaust heat exchanger 40, the HTF 22 is heated by the exhaust gases 18, and the exhaust gases 18 are cooled. Cooled exhaust gases 46 exit the exhaust heat exchanger 40 and are returned to the stack 38. In certain embodiments, all of the exhaust gases 18 may be directed to the exhaust heat exchanger 40 for cooling. Venting the cooled exhaust gases 46 to the atmosphere may generally improve the efficiency of the gas turbine system 10.

An inlet control valve 48 and an outlet control valve 50 are disposed along the exhaust gas flow path 44. The control valves 48 and 50 may throttle flow of the exhaust gases 18 to the exhaust heat exchanger 40. For example, during start-up of the gas turbine system 10, it may be desirable to vent all of the exhaust gases 18 to the atmosphere. Accordingly, the control valves 48 and 50 may be closed to isolate the exhaust heat exchanger 40 from the stack 38. During normal operation of the gas turbine system 10, it may be desirable to recover waste heat from the exhaust gases 18 using the anti-icing system 20, and the control valves 48 and 50 may be opened. Accordingly, a controller 70 (e.g., anti-icing controller or turbine heat recovery controller) is communicatively coupled to the control valves 48 and 50. The controller 70 may implement logic to selectively open or close the control valves 48 and 50 based on an operating condition of the gas turbine system 10, as will be discussed in detail further below. In particular, the controller 70 includes logic (e.g., stored instructions stored on a non-transitory, tangible, computer-readable medium) to selectively heat the air 14, the fuel 16, the HTF 22, or any combination thereof.

The anti-icing system 20 includes a tank or skid 52 to store the HTF 22. The HTF 22 exits the skid 52 and flows to the exhaust heat exchanger 40, where the HTF 22 is warmed by the exhaust gases 18. In certain embodiments, it may be desirable to control a flow rate of the HTF 22 exiting the skid 52. To this end, a pump 54, a control valve 56, and a flow meter 58 are disposed along a flow path 60 of the HTF 22. The pump 54 transports the HTF 22 to the heat exchangers 30, 32, and 40 of the anti-icing system 20. The control valve 56 may throttle a flow rate of the HTF 22, and the flow meter 58 may detect the resulting flow rate of the HTF 22. As shown, a controller 62 is communicatively coupled to the control valve 56 and the flow meter 58. The controller 62 may receive a signal from the flow meter 58 as an indication of the HTF flow rate, and the controller 62 may adjust the control valve 56 in response. For example, it may be desirable for the anti-icing system 20 to have a constant flow of the HTF 22. The controller 62 may adjust the control valve 56 based on the signal from the flow meter 58 in order to provide an approximately constant flow of the HTF 22, thereby increasing the operability of the anti-icing system 20. In a presently contemplated embodiment, the flow of the HTF 22 may be between approximately 250 to 1000, 450 to 750, or 520 to 650 gallons per minute (between approximately 900 to 3800, 1500 to 2800, or 1900 to 2500 liters per minute).

As illustrated, the HTF 22 exchanges heat with the exhaust gases 18, and warmed HTF 64 exits the exhaust heat exchanger 40. A temperature sensor 66 is disposed along a flow path 68 of the warmed HTF 64 and detects a temperature of the warmed HTF 64. In certain embodiments, the temperature of the warmed HTF 64 may be affected by the amount of exhaust gases 18 directed to the exhaust heat exchanger by the blower 42. For example, larger amounts of exhaust gases 18 may generally increase the temperature of the warmed HTF 64. In certain embodiments, it may be desirable to adjust the blower 42 to adjust the temperature of the warmed HTF 64. Thus, the controller 70 is also communicatively coupled to the blower 42 and the temperature sensor 66. The controller 70 receives a signal from the temperature sensor 66 as an indication of the temperature of the warmed HTF 64. In response to the signal, the controller 70 may adjust an operating condition of the blower 42. For example, the blower 42 may be driven by a variable frequency drive (VFD). The controller 70 may adjust a speed of the VFD, thereby adjusting the amount of exhaust gases 18 directed to the exhaust heat exchanger 40, and ultimately adjusting the temperature of the warmed HTF 64.

After exiting the exhaust heat exchanger 40, the warmed HTF 64 may be directed through one or more fluid loops of the anti-icing system 20. The illustrated anti-icing system 20 includes an anti-icing loop 72, an HTF reheating loop 74, and a fuel heating loop 76. However, the number of fluid loops of the anti-icing system 20 may vary. For example, it may be desirable to heat upstream or downstream systems of the gas turbine system 10 using the heat from the exhaust gases 18. Thus, the anti-icing system 20 may include 1, 2, 3, 4, 5, 6, or more fluid loops to direct the warmed HTF 64 within the gas turbine system 10, to components outside of the gas turbine system 10, or both.

Within the anti-icing loop 72, the warmed HTF 64 is directed to the air heat exchanger 30, where the warmed HTF 64 provides heat to the filtered air 28. Cooled HTF 82 exits the air heat exchanger 30 and returns to the skid 52, where the cycle essentially begins again. Notably, the anti-icing loop 72 bypasses the fuel heat exchanger 32. However, in certain configurations, the warmed HTF 64 may be directed through both of the anti-icing loop 72 and the fuel heating loop 76.

As illustrated, the anti-icing loop 72 includes an inlet control valve 84 and an outlet control valve 86. The control valves 84 and 86 may selectively enable or block flow to the air heat exchanger 30. For example, when the control valves 84 and 86 are closed, the air heat exchanger 30 may be isolated from the warmed HTF 64. It may be desirable to isolate the air heat exchanger 30 for various reasons, such as when the temperature of the warmed HTF 64 is too low (e.g., below 66 degrees Celsius), or when the temperature of the heated air 31 is sufficiently high (e.g., above 8 degrees Celsius).

A temperature sensor 78 is disposed along the air flow path 26. The temperature sensor 78 detects the temperature of the heated air 31. In certain embodiments, the temperature of the heated air 31 may be affected by the flow rate of the warmed HTF 64 to the air heat exchanger 30. In addition, it may be desirable to control the temperature of the heated air 31 using the controller 70. Thus, the controller 70 is communicatively coupled to the inlet control valve 84, the outlet control valve 86, and the temperature sensor 78. The controller 70 may adjust the temperature of the heated air 31 by throttling the control valves 84 and 86. For example, when the temperature of the heated air 31 is too low, the controller 70 may open the inlet control valve 84 to enable a greater flow rate of warmed HTF 64 to the air heat exchanger 30. In other words, the controller 70 may control the flow rate of the warmed HTF 64 based on the temperature of the heated air 31 and/or a rate of change of the temperature of the heated air 31 (e.g., proportional control and/or derivative control). Additionally or alternatively, the controller 70 may control the flow rate of the warmed HTF 64 based on the ambient temperature. To this end, an ambient temperature sensor 79 may detect a temperature of the air 14 as an indication of the ambient temperature. As noted earlier, heating the air 14 using the warmed HTF 64 may reduce the possibility of icing within the gas turbine system 10, thereby improving the operability of the gas turbine system 10.

As discussed above, the controller 70 may control the temperature of the heated air 31 or the heated fuel 34 by adjusting the flow rate of the warmed HTF 64. However, in certain embodiments, it may be desirable to maintain the flow rate of the warmed HTF 64 to be approximately constant. In such an embodiment, the controller 70 may control the temperature of the heated air 31 or the heated fuel 34 by adjusting the operation of the blower 42. For example, increasing a speed of the blower 42 may increase the amount of exhaust gases 18 directed to the exhaust heat exchanger 40, thereby increasing a temperature of the warmed HTF 64. The warmed HTF 64 may exchange more heat with the air 14 or the fuel 16, which results in a higher temperature of the heated air 31 or the heated fuel 34. In certain embodiments, the controller 70 may control the temperature of the heated air 31 or the heated fuel 34 by adjusting both the flow rate of the warmed HTF 64 and the operation of the blower 42.

Within the HTF reheating loop 74, the warmed HTF 64 is directed back to the skid 52. That is, the HTF 22 flows through a closed loop from the skid 52, to the exhaust heat exchanger 40, and back to the skid 52 rather than to the air and fuel heat exchangers 30 and 32. Thus, HTF reheating loop 74 bypasses both the air heat exchanger 30 and the fuel exchanger 32. As a result, the HTF reheating loop 74 enables the temperature of the warmed HTF 64 to be increased relatively quickly using the exhaust gases 18. In certain embodiments, it may be desirable to heat the air 14 and/or the fuel 16 using the warmed HTF 64 after the warmed HTF 64 has reached a setpoint temperature. For example, during startup operation of the gas turbine system 10, the temperature of the HTF 22 may be insufficient to heat the air 14 and/or the fuel 16. The HTF 22 may be re-circulated within the HTF reheating loop 74 until the setpoint temperature is reached. In a presently contemplated embodiment, the setpoint temperature for the warmed HTF 64 may be between approximately 32 to 200, 59 to 170, 148 to 152 degrees Fahrenheit, and all subranges therebetween (e.g., between approximately 0 to 93, 15 to 76, 64 to 67 degrees Celsius, and all subranges therebetween). In addition, the controller 70 may automatically enable flow through the HTF reheating loop 74 when the temperature of the warmed HTF 64 is below a threshold temperature. Automatically reheating the warmed HTF 64 may allow for reliable operation of the anti-icing system 20. In a presently contemplated embodiment, the threshold temperature for automatic reheating may be less than approximately 150, 120, or 100 degrees Fahrenheit (e.g., less than approximately 66, 49, or 38 degrees Celsius).

In addition, while the HTF 22 is reheated within the HTF reheating loop 74, it may be desirable to maintain the temperature of the heated air 31 above a setpoint temperature. To this end, the controller 70 may adjust operation of the blower 42 accordingly. In a presently contemplated embodiment, the setpoint temperature of the heated air 31 may be between approximately 200 to 400, 250 to 350, 295 to 305 degrees Fahrenheit, and all subranges therebetween (between approximately 93 to 204, 121 to 177, 146 to 152 degrees Celsius, and all subranges therebetween).

The HTF reheating loop 74 includes a control valve 80 disposed along a flow path of the warmed HTF 64. The control valve 80 selectively enables or blocks flow through the HTF reheating loop 74. For example, when the warmed HTF 64 is heating the air 14 and/or the fuel 16, it may be desirable to minimize the flow of bypassing the air and fuel heat exchangers 30 and 32 through the HTF reheating loop 74. Thus, the controller 70 is also communicatively coupled to the control valve 80 and may open or close the control valve 80 based on a desired operation of the anti-icing system 20. That is, the controller 70 may selectively heat the HTF 22 through the HTF reheating loop 74, the air through the anti-icing loop 72, and/or the fuel through the fuel heating loop 76, as will be discussed further below.

Within the fuel heating loop 76, the warmed HTF 64 is directed to the fuel heat exchanger 32, where the warmed HTF 64 provides heat to the fuel 16. As noted above, using the HTF 64 to heat the fuel 16 reduces the possibility or magnitude of sulfur deposition, thereby improving the operability and efficiency of the gas turbine system 10. After exchanging heat with the fuel 16, the cooled HTF 82 exits the fuel heat exchanger 32 and returns to the skid 52, where the cycle essentially begins again. Notably, the fuel heating loop 76 bypasses the air heat exchanger 30. However, in certain embodiments, the controller 70 may direct the warmed HTF 64 through both the anti-icing loop 72 and the fuel heating loop 76 to simultaneously heat the air 14 and the fuel 16 using the warmed HTF 64.

As illustrated, the fuel heating loop 76 includes an inlet control valve 88 and an outlet control valve 90. The control valves 88 and 90 may selectively enable or block flow to the fuel heat exchanger 32. For example, when the control valves 88 and 90 are closed, the fuel heat exchanger 32 may be isolated from the warmed HTF 64. It may be desirable to isolate the fuel heat exchanger 32 for various reasons, such as when the temperature of the warmed HTF 64 is too low (e.g., less than approximately 66 degrees Celsius), or when the temperature of the heated fuel 34 is sufficiently high (e.g., above approximately 54 degrees Celsius).

A temperature sensor 92 is disposed along the fuel flow path 33. The temperature sensor 92 detects the temperature of the heated fuel 34. In certain embodiments, the temperature of the heated fuel 34 may be affected by the flow rate of the warmed HTF 64 to the fuel heat exchanger 32. Accordingly, the controller 70 is communicatively coupled to the control valves 88 and 90 and the temperature sensor 92. The controller 70 may throttle the control valves 88 and 90 to adjust the temperature of the heated fuel 34 towards a setpoint temperature. In a presently contemplated embodiment, the setpoint temperature may be between approximately 100 to 150, 110 to 140, 125 to 135 degrees Fahrenheit, and all subranges therebetween (between approximately 37 to 66, 43 to 60, 51 to 57 degrees Celsius, and all subranges therebetween).

The controller 70 may enable flow through the fuel heating loop 76 when certain operating conditions are met. For example, when an ambient temperature would indicate an icing condition (e.g., actual ice formation or conditions conducive to the formation of ice), it may be desirable to prioritize heating the air 14 over heating the fuel 16. That is, when an icing condition exists, the HTF reheating loop 74 and the fuel heating loop 76 may be closed to increase the supply of warmed HTF 86 available for the anti-icing loop 72. In certain embodiments, the icing condition may be defined as an ambient temperature of less than 60, 50, or 47 degrees Fahrenheit (e.g., less than approximately 16, 10, or 8 degrees Celsius).

In addition, the controller 70 may enable flow through the fuel heating loop 76 when the ambient temperature is within an acceptable temperature range. In a presently contemplated embodiment, the acceptable temperature range for the ambient temperature may be between approximately −20 to 120, 0 to 110, 32 to 106 degrees Fahrenheit, and all subranges therebetween (between approximately −28 to 49, −18 to 43, 0 to 42 degrees Celsius, and all subranges therebetween). Additionally or alternatively, the controller 70 may enable flow through the fuel heating loop 76 when the temperature of the fuel 16 is within an acceptable temperature range. In certain embodiments, the acceptable temperature range for the fuel 16 may be between approximately 0 to 200, 10 to 170, 18 to 140 degrees Fahrenheit, and all subranges therebetween (between approximately −17 to 93, −12 to 77, −8 to 60 degrees Celsius, and all subranges therebetween).

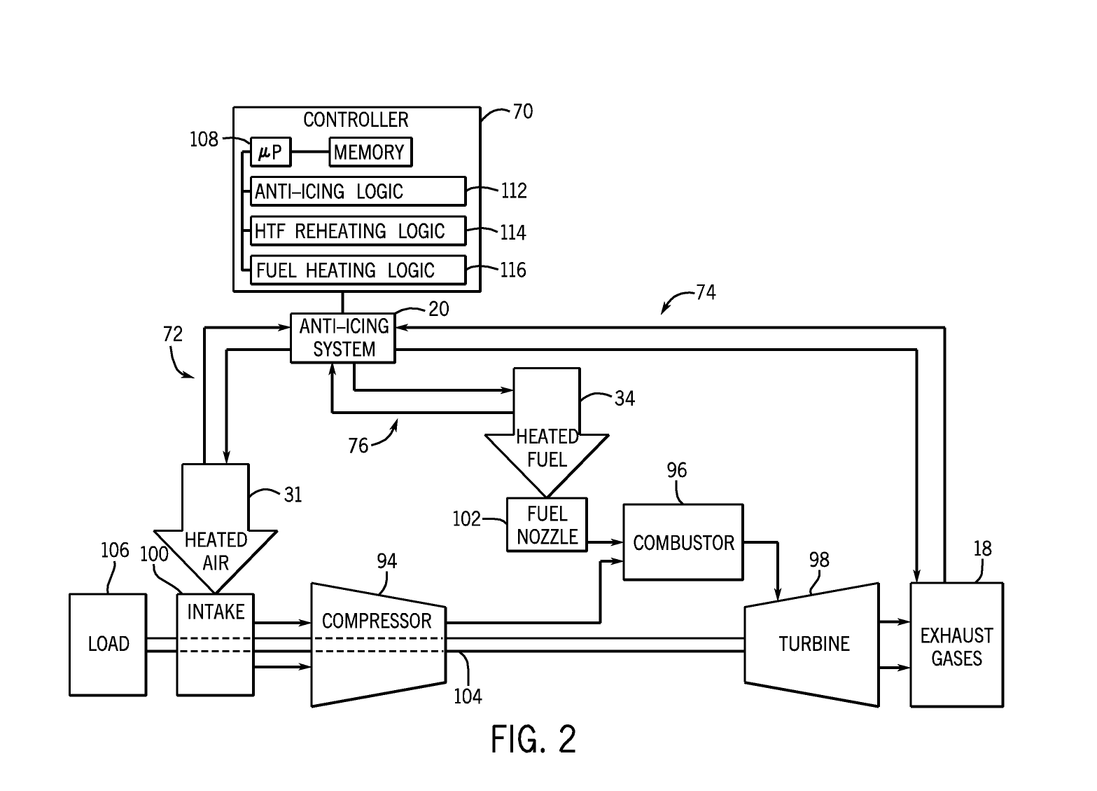

As will be discussed further in FIG. 2, operation of the gas turbine system 10 may be governed by the controller 70, which implements logic to enable the warmed HTF 64 to selectively flow through the fluid loops 72, 74, and 76 of the anti-icing system 20. FIG. 2 illustrates various components of the gas turbine 12 coupled to the controller 70 and the anti-icing system 20.

As shown in FIG. 2, the gas turbine 12 includes a compressor 94, a combustor 96, and a turbine 98. The compressor 94 receives the heated air 31 from an intake 100 and compresses the air 14 for delivery to the combustor 96. The combustor 96 also receives the heated fuel 34 from fuel nozzles 102. The heated air 31 and the heated fuel 34 mix and react to form combustion products within the combustor 96. The hot combustion products are fed into the turbine 98, which causes a shaft 104 to rotate. The shaft 104 is also coupled to the compressor 94 and a load 106. The rotating shaft 104 provides the energy for the compressor 94 to compress the heated air 31, as described previously. The load 106 may be an electric generator or any device capable of utilizing the mechanical energy of the shaft 104. Finally, the combustion products exit the turbine 98 as the exhaust gases 18.

As illustrated, the controller 70 includes various components to implement the logic to selectively heat the HTF 22 using the exhaust gases 18, the air 14 using the warmed HTF 64, the fuel 16 using the warmed HTF 64. The controller 70 includes one or more processors 108 and/or other data processing circuitry, such as memory 110, to execute instructions to enable selective heating of the air 14, the fuel 16, and the HTF 22. These instructions may be encoded in software programs that may be executed by the one or more processors 108. For example, the processor 108 may select an HTF reheating mode, wherein the warmed HTF 64 is routed through the HTF reheating loop 74 and bypasses the air and fuel heat exchangers 30 and 32. Further, the instructions may be stored in a tangible, non-transitory, computer-readable medium, such as the memory 110. The memory 110 may include, for example, random-access memory, read-only memory, rewritable memory, hard drives, and the like. In certain embodiments, the various temperature setpoints and thresholds may be encoded and stored within the memory 110 to be later accessed by the one or more processors 108.

The controller 70 may implement an anti-icing logic 112, an HTF reheating logic 114, a fuel heating logic 116, or any combination thereof. Each of the logic 112, 114, and 116 corresponds to the respective fluid loops 72, 74, and 76. For example, the anti-icing logic 112 enables flow through the anti-icing loop 72, as discussed above. That is, the anti-icing logic 112 may include isolating the fuel heat exchanger 32 from the warmed HTF 64 and enabling the warmed HTF 64 to flow to the air heat exchanger 30. In the embodiment illustrated by FIG. 1, isolating the fuel heat exchanger 32 may include closing the valves 80, 88, and 90. As illustrated, enabling flow to the air heat exchanger may also include opening the valves 84 and 86.

Similarly, the fuel heating logic 116 enables flow through fuel heating loop 76, as discussed above. That is, the fuel heating logic 116 may include isolating the air heat exchanger 30 from the warmed HTF 64 and enabling the warmed HTF 64 to flow to the fuel heat exchanger 32. Isolating the air heat exchanger 30 may include closing the valves 80, 84, and 86, while enabling flow to the air heat exchanger 30 may include opening the valves 88 and 90. In certain embodiments, it may be desirable to simultaneously enable flow to both of the air and fuel heat exchangers 30 and 32. To this end, the controller 70 may implement certain portions of the anti-icing logic 112 and the fuel heating logic 116.

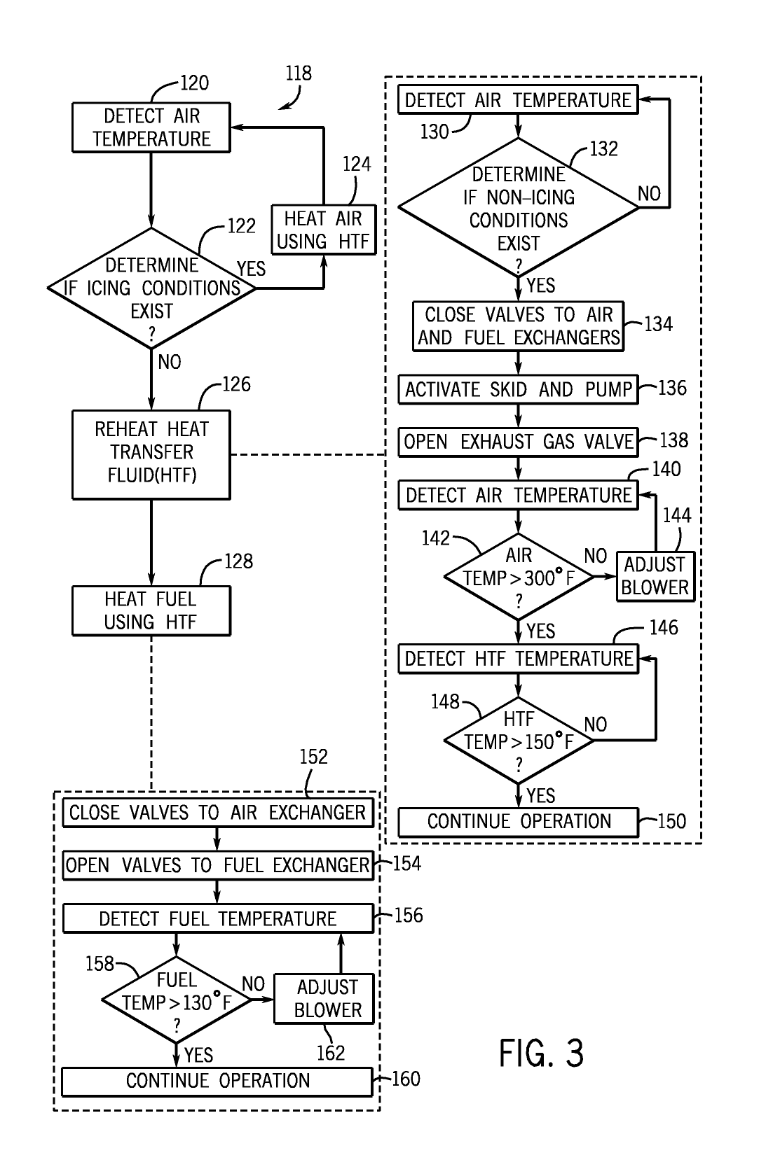

The HTF reheating logic 114 enables flow through the HTF reheating loop 74. Thus, the HTF reheating logic may include isolating both the air heat exchanger 30 and the fuel heat exchanger 32 from the warmed HTF 64. Accordingly, the controller 70 may close the valves 84, 86, 88, and 90 to isolate the air and fuel heat exchangers 30 and 32. In addition, the controller 70 may open the valve 80 to enable the warmed HTF 64 to be re-circulated within the HTF reheating loop 74. The logic 112, 114, and 116 of the controller 70 are discussed in greater detail with respect to FIG. 3.

FIG. 3 illustrates a flowchart of a method 118 to heat the fuel 16 using the anti-icing system 20 to improve the efficiency and operability of the gas turbine system 10. The ambient temperature sensor 79 may detect (block 120) the temperature of the air 14 as an indication of the ambient temperature. The controller 70 may determine (block 122) if an icing condition exists. In certain embodiments, the icing condition may be based on ambient conditions, such as temperature, pressure, relative humidity, and the like. Accordingly, the sensor 79 may detect the ambient temperature, pressure, relative humidity, and the like. In a presently contemplated embodiment, an icing condition may be defined as an ambient temperature of less than approximately 60, 50, or 47 degrees Fahrenheit (less than 16, 10, or 8 degrees Celsius). If the controller 70 determines (block 122) that an icing condition exists, the controller 70 may heat (block 124) the air 14 within the air heat exchanger 30 using the warmed HTF 64. That is, the controller 70 may implement anti-icing logic 112 using the anti-icing loop 72. However, when an icing condition does not exist, the controller 70 may reheat (block 126) the HTF 22 using heat from the exhaust gases 18. In other words, the controller 70 may implement HTF reheating logic 114 using the HTF reheating loop 74. After the HTF 22 has been warmed to a sufficient level, the controller 70 may heat (block 128) the fuel 16 using the warmed HTF 64. In other words, the controller 70 may implement fuel heating logic 116 using the fuel heating loop 76, as discussed above. In certain embodiments, the controller 70 may reheat (block 126) the HTF 22 until the temperature of the warmed HTF 64 exceeds approximately 120, 130, or 148 degrees Fahrenheit (exceeds approximately 49, 54, or 64 degrees Celsius). Reheating (block 126) the HTF 22 and heating (block 128) the fuel using the warmed HTF 64 is discussed in greater detail below.

Reheating (block 126) the HTF 22 using the HTF reheating logic 114 may include various implementation-specific steps, as illustrated in FIG. 3. The ambient temperature sensor 79 may detect (block 130) a temperature of the air 14 as an indication of the ambient temperature. The controller 70 may then determine (block 132) if a non-icing condition exists. As noted above, the non-icing condition may be based at least in part on ambient conditions, such as temperature, pressure, relative humidity, weather conditions (e.g., rain, snow, etc.) and the like. Accordingly, the sensor 79 may detect the ambient temperature, pressure, relative humidity, and the like. In a presently contemplated embodiment, the non-icing condition may be defined by a temperature range of between approximately 30 to 150, 35 to 140, 43 to 106 degrees Fahrenheit, and all subranges therebetween (between approximately −1 to 66, 1 to 60, 6 to 42 degrees Celsius, and all subranges therebetween). When a non-icing condition exists, the controller 70 may isolate the air and fuel heat exchangers 30 and 32 by closing (block 134) certain valves within the gas turbine system 10. As illustrated in FIG. 1, the controller 70 may close (block 134) valves 84, 86, 88, and 90 to isolate the heat exchangers 30 and 32.

The controller 70 may then activate (block 136) the skid 52 and the pump 54. Activating (block 136) the skid 52 and the pump 54 may include powering various instrumentation of the skid 52 and starting up the pump 54. Once the pump 54 has begun to circulate the HTF 22 within the HTF reheating loop 74, the controller 70 may open (block 138) the control valves 48 and 50 to enable the exhaust gases 18 to flow to the exhaust heat exchanger 40. The temperature sensor 78 may detect (block 140) the temperature of the heated air 31. The controller 70 may then determine (block 142) if the temperature of the heated air 31 is above a setpoint temperature (e.g., approximately 148 degrees Celsius). If the temperature of the heated air 31 is not above the setpoint temperature, the controller 70 may adjust (block 144) an operating condition of the blower 42 in response. As discussed earlier, the blower 42 may be driven by a VFD, and the controller 70 may adjust the speed of the VFD.

When the temperature of the heated air 31 is above the setpoint temperature, the temperature sensor 66 may detect (block 146) the temperature of the warmed HTF 64. The controller 70 may then determine (block 148) if the temperature of the warmed HTF 64 is above a setpoint temperature (e.g., approximately 66 degrees Celsius). If the temperature of the warmed HTF 64 is above the setpoint temperature, the controller 70 may continue (block 150) operation by heating (block 128) the fuel 16 using the warmed HTF 64.

Heating (block 128) the fuel 16 using the warmed HTF 64 may include multiple steps, as illustrated. The controller 70 may close (block 152) the valves 84 and 86 to isolate the air heat exchanger 30. In addition, the controller 70 may close (block 152) the valve 80 to isolate the HTF reheating loop 74. The controller 70 may also open (block 154) the valves 88 and 90 to enable the warmed HTF 64 to flow to the fuel heat exchanger 32. The temperature sensor 92 may detect (block 156) a temperature of the heated fuel 34. In addition, the controller 70 may determine (block 158) if the temperature of the heated fuel 34 is above a setpoint temperature (e.g., approximately 54 degrees Celsius). In certain embodiments, the setpoint temperature of the heated fuel may be between approximately 100 to 160, 110 to 150, 125 to 135 degrees Fahrenheit, and all subranges therebetween (between approximately 37 to 66, 43 to 60, 51 to 57 degrees Celsius, and all subranges therebetween). When the temperature of the heated fuel 34 is above the setpoint temperature, the controller may continue (block 160) operation of the gas turbine system 10. However, when the temperature of the heated fuel 34 is not above the setpoint temperature, the controller may adjust (block 162) the blower 42 to increase the temperature of the heated fuel 34 above the setpoint temperature.

Technical effects of the disclosed embodiments include an anti-icing system 20 may use the HTF 22 to extract waste heat from the gas turbine 12 and to redistribute the waste heat among various components of the gas turbine system 10. For example, the HTF 22 may extract heat from exhaust gases 18 of the gas turbine 12 and redistribute the heat to the fuel 16 and/or the air 14 to the gas turbine. Heating the air 14 using the heat from the exhaust gases 18 reduces the possibility of icing within the gas turbine system, thereby increasing the operability of the gas turbine system 10. In addition, heating the fuel 16 using the heat from the exhaust gases 18 improves the overall efficiency of the gas turbine system 10 and reduces the possibility of sulfur deposition. In certain embodiments, the controller 70 may be employed to selectively heat the air 14, the fuel 16, the HTF 22, or any combination thereof, based at least in part on operating conditions of the gas turbine system 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas turbine configured to receive air and fuel and to combust a mixture of the air and the fuel into exhaust gases; and
an anti-icing system coupled to the gas turbine and configured to use heat from the exhaust gases to heat a heat transfer fluid (HTF) and to selectively heat the fuel and the air via the HTF.

2. The system of claim 1, wherein the anti-icing system comprises:
an exhaust heat exchanger disposed downstream of the gas turbine along an exhaust gas flow path and configured to selectively heat the HTF using the exhaust gases;
an air heat exchanger disposed upstream of the gas turbine along an air flow path and configured to selectively heat the air using the HTF; and
a fuel heat exchanger disposed upstream of the gas turbine along a fuel flow path and configured to selectively heat the fuel using the HTF.

3. The system of claim 2, wherein the anti-icing system comprises a first loop having a first HTF flow path, wherein the HTF along the first HTF flow path is configured to bypass the fuel and air heat exchangers and to exchange heat with the exhaust gases to increase a temperature of the HTF above an HTF temperature setpoint.

4. The system of claim 3, wherein the HTF temperature setpoint is between approximately 15 and 76 degrees Celsius.

5. The system of claim 3, wherein the first loop comprises:
a pump disposed along the first HTF flow path and configured to pump the HTF between a skid and the exhaust heat exchanger;
a control valve disposed downstream of the pump, wherein the control valve is configured to throttle a flow rate of the HTF;
a flow meter configured to detect the flow rate of the HTF; and
a controller configured to adjust the control valve based at least in part on the flow rate of the HTF.

6. The system of claim 5, wherein the system comprises a blower configured to direct the exhaust gases to the exhaust heat exchanger, and wherein the controller is configured to adjust the blower based at least in part on a temperature of the HTF.

7. The system of claim 2, wherein the anti-icing system comprises a second loop having a second HTF flow path, wherein the HTF along the second HTF flow path is configured to bypass the air heat exchanger and to exchange heat with the fuel to increase a temperature of the fuel above a fuel temperature setpoint.

8. The system of claim 7, wherein the second loop comprises:
a control valve configured to throttle a flow rate of the HTF; and
a controller configured to adjust the control valve based at least in part on the temperature of the fuel.

9. The system of claim 8, wherein the controller is configured to open the control valve to enable the HTF to flow through the control valve along the second HTF flow path when the temperature of the fuel is between approximately between −8 and 60 degrees Celsius.

10. The system of claim 8, wherein the controller is configured to enable the HTF to flow through the control valve when an ambient temperature is between approximately 0 and 42 degrees Celsius.

11. The system of claim 2, wherein the anti-icing system comprises a third loop having a third HTF flow path, wherein the HTF along the third HTF flow path is configured to bypass the fuel heat exchanger and to exchange heat with the air to increase a temperature of the air above an air temperature setpoint.

12. The system of claim 11, wherein the third loop comprises:
a control valve configured to throttle a flow rate of the HTF; and
a controller configured to adjust the control valve based at least in part on the temperature of the air.

13. A system, comprising:
a turbine heat recovery controller, comprising:
a reheating logic configured to control heating of a heat transfer fluid (HTF) using exhaust gases of a gas turbine system;
an anti-icing logic configured to control heating of air of the gas turbine system using the HTF; and
a fuel heating logic configured to control heating of a fuel of the gas turbine system using the HTF.

14. The system of claim 13, wherein the reheating logic is configured to control an HTF flow to isolate an air heat exchanger and a fuel heat exchanger from the HTF, and to control the heating of the HTF within an exhaust heat exchanger of the gas turbine system.

15. The system of claim 13, wherein the fuel heating logic is configured to control an HTF flow to isolate an air heat exchanger from the HTF and to control the heating of the fuel within a fuel heat exchanger of the gas turbine system.

16. A method, comprising:
detecting an air temperature of air using a first temperature sensor;
determining if an icing condition exists based at least in part on the air temperature;
heating the air within an air heat exchanger using a heat transfer fluid (HTF) heated by exhaust gases of a gas turbine when the icing condition exists;
reheating the HTF within an exhaust heat exchanger using the exhaust gas of a gas turbine when the icing condition does not exist; and
heating a fuel within a fuel heat exchanger using the HTF when the icing condition does not exist.

17. The method of claim 16, wherein reheating the HTF comprises:
re-detecting the air temperature of the air using the first temperature sensor;
determining if a non-icing condition exists based at least in part on the air temperature;
enabling the HTF to flow through the exhaust heat exchanger when the non-icing condition exists;
detecting an HTF temperature of the HTF using a second temperature sensor;
determining if the HTF temperature exceeds an HTF setpoint temperature; and
increasing the HTF temperature using the exhaust gases when the HTF temperature does not exceed the HTF setpoint temperature.

18. The method of claim 17, wherein reheating the HTF is performed when the HTF temperature is less than approximately 38 degrees Celsius, and wherein the HTF setpoint temperature is between approximately between 60 and 76 degrees Celsius.

19. The method of claim 16, wherein heating the fuel comprises:
enabling the HTF to flow through the exhaust heat exchanger and the fuel heat exchanger when the icing condition does not exist;
detecting a fuel temperature of the fuel using a second temperature sensor;
determining if the fuel temperature of the fuel exceeds a fuel setpoint temperature; and
increasing the fuel temperature using the HTF when the fuel temperature does not exceed the fuel setpoint temperature.

20. The system of claim 19, wherein heating the fuel is performed when the fuel temperature of the fuel is between approximately −8 and 60 degrees Celsius, and wherein the fuel setpoint temperature is between approximately 51 and 57 degrees Celsius.
